(19) United States
(12) Patent Application Publication
(10) Pub. No.: US 2013/0133518 A1
(43) Pub. Date: May 30, 2013

(54) ELECTROSTATIC PRECIPITATOR WITH DUAL ENERGY ZONE DISCHARGE ELECTRODES

(71) Applicants: Robert A. Allan, Kitchener (CA); Egbert Van Everdingen, Kitchener (CA)

(72) Inventors: Robert A. Allan, Kitchener (CA); Egbert Van Everdingen, Kitchener (CA)

(73) Assignee: TURBOSONIC INC., Waterloo, ON (CA)

(21) Appl. No.: 13/638,639

(22) PCT Filed: Mar. 29, 2011
(86) PCT No.: PCT/CA2011/000327

§ 371 Date: Feb. 12, 2013

(30) Foreign Application Priority Data
Mar. 31, 2010 (US) 61282780

(51) Int. Cl. B03C 3/16

(52) U.S. Cl. CPC B03C 3/16
USPC 96/52; 96/80

(57) ABSTRACT

An electrostatic precipitator, particularly a WESP, comprising an array of collector tubes and a like array of separately powered discharge electrodes provided in the form of pairs of rods extending within each of the collector tubes. The pairs of rods are provided in the form of a first length rod having a terminal end, the first length rod powered by a first power source, and an axially opposed, second length rod having a terminal end, the second length rod powered by a second power source, wherein each first length discharge electrode rod, of a pair of rods, extends from an inlet of the electrostatic precipitator into a respect e collector tube and each second length discharge electrode rod, of the same pair of rods, extends from an outlet of the electrostatic precipitator into the same, respect e collector tube such that the respective terminal ends of the pairs of discharge electrode rods are spaced apart, thereby defining a gap therebetween. This arrangement enables different energy levels to be applied to each of the first and second length discharge electrode rods of the pairs of discharge electrode rods, by the first and second power supplies, respectively, thereby inducing different levels of ionization within a gas stream flowing through the collector tube array of the electrostatic precipitator, at different locations within the electrostatic precipitator.

### REFERENCE TO RELATED APPLICATION

This application claims priority under 35 USC 119(e) from U.S. Provisional Patent Application No. 61/282,780 filed Mar. 31, 2010.

### FIELD OF THE INVENTION

The present invention relates to electrostatic precipitators, particularly with wet electrostatic precipitators (WESPs).

### BACKGROUND TO THE INVENTION

Wet electrostatic precipitators (WESP) have been used for many years to remove dust, acid mist and other particulates from water-saturated air and other gases by electrostatic means. In a WESP, particulates and/or mist laden water-saturated air flows in a region of the precipitator between discharge and collecting electrodes, where the particulates and/or mist is electrically charged by corona emitted from the high voltage discharge electrodes. As the water-saturated gas flows further within the WESP, the charged particulates matter and/or mist is electrostatically attracted to grounded collecting plates or electrodes where it is collected. The accumulated materials are continuously washed off by both an irrigating film of water and periodic flushing. WESPs usually comprise a bundle of electrically-conducting grounded collecting electrical tubes within each of which is suspended an elongate electrically-conducting corona discharge electrode.

This type of system is used to remove pollutants from the gas streams exhausting from various industrial sources, such as incinerators, coke ovens, glass furnaces, non-ferrous metallurgical plants, coal-fired generation plants, forest product facilities, food drying plants and petrochemical plants.

### SUMMARY OF THE INVENTION

In accordance with the present invention, a modified form of a WESP is provided in which two discharge zones for charging and collecting particulates are provided within a single unit. The two zones have a common ground and the discharge electrodes are connected to different power sources to permit different levels of energy to be applied to the two separate zones.

The two discrete zones within the WESP may be provided by providing two discharge electrodes of differing length within a common collector electrode with each of the two discharge electrodes being connected to a separate power source.

This arrangement enables different energy levels to be applied to the gas stream at different locations in the WESP. In particular, a higher energy corona discharge field may be applied close to the inlet to the WESP, where the highest level of contamination exists, and a lower energy corona discharge field may be applied closer to the outlet from the unit, where the level of contamination is lower, leading to more efficient removal of contaminants in a more compact unit.

Accordingly, in one aspect of the present invention, there is provided as electrostatic precipitator unit, comprising an outer housing having an inlet for a gas stream to be treated in the electrostatic precipitator and an outlet for treated gases, an array of electrically-conducting tubes located within the housing and extending continuously from adjacent the inlet to adjacent the outlet, the array of tubes being electrically grounded to permit the array of tubes to act as collecting surfaces for particulate removal from the gas stream, pairs of elongate rod electrodes located in each of the tubes, with one member of each pair of electrodes extending a first distance from one end of the tubes and the other member of each pair of electrodes extending a second distance from the other end of the tubes to be spaced apart from one another, the one member of each pair of electrodes being electrically powered by a first power supply and the other member of each pair of electrodes being electrically powered by a second power supply to permit each pair of electrodes to act as ionizing electrodes for the gas stream, wherein, in operation, differing power levels may be applied by the first and second power supply to gas flowing through the array of tubes during the first distance and to gas flowing in the array of tubes during the second distance.

Each of the pairs of electrodes is preferably spaced apart in its respective tube at least a distance such that the corona discharge field produced by the one member of the pair of electrodes does not interfere with the corona discharge field produced by the other member of the pair of electrodes.

The tubes employed in the electrostatic precipitator may have any desired cross-sectional shape including polygonal, preferably hexagonal, or round.

The tubes employed in the electrostatic precipitator may be constructed of any convenient construction material, including carbon steel, stainless steel, corrosion- and temperature-resistant alloys, lead and fiberglass reinforced plastics. The material of construction of the tubes preferably is an electrically-conductive corrosion resistant and temperature- and spark-resistant composite material with good heat dissipation, as described in copending U.S. patent applications Ser. No. 12/451,662 (WO 2008/154,735) and Ser. No. ______ (WO 2010/108,256). Such materials comprise carbon fiber with a thermosetting resin and a cross-linked structure.

The electrostatic precipitator may be provided in any desired orientation, such as a vertical orientation. In such vertical orientation, the inlet may be at the upper end or at the lower end, as desired.

### BRIEF DESCRIPTION OF DRAWINGS

FIG. 1 is a schematic sectional view of a WESP constructed in accordance with one embodiment of the invention.

### DESCRIPTION OF PREFERRED EMBODIMENT

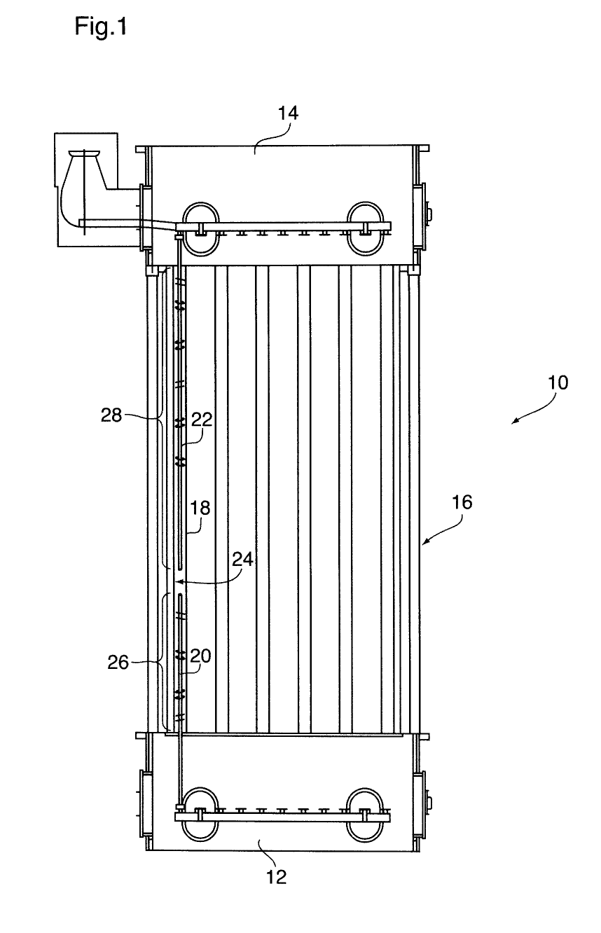

Referring to FIG. 1, a WESP unit 10 has a vertical orientation with a lower inlet 12 and an upper outlet 14. Extending between the inlet and the outlet is a bundle of collector tubes 16. The specific arrangement with respect to one of the tubes 18 is shown in detail, but it will be understood that the arrangement of discharge electrodes and collecting electrodes is the same throughout the bundle.

While the WESP unit 10 is shown with a vertical orientation and with a lower inlet and upper outlet, other arrangements are equally feasible, such as an upper inlet and a lower outlet. In addition to the unit may be arranged horizontally, if desired.

The collector tube 18 has two discharge electrode rods 20 and 22 extending therewithin, one, 20, extending from below and the other, 22, extending from above, with their respective termini defining a vertical gap 24 therebetween. The discharge electrode rods 20 extending from below are connected to a first power source (not shown) while the discharge electrode rods 22 extending from above are connected to a second separate power source (not shown). In this manner, the discharge electrodes 20 and 22 are provided independently and may form corona discharge fields of differing strength, providing two distinct zones 26 and 28 for charging and collection of particulates within a single WESP unit 10.

In operation of the WESP 10, differing power levels may be applied in the two zones 26 and 28, to permit greater power to be applied closer to the inlet in zone 26, where the level of contamination of the gas stream is the highest, while lesser power is applied closer to the outlet in zone 28 where the level of contamination is at a lower level, providing optimization of power input and greater flexibility and efficiency of operation of the WESP.

### SUMMARY OF THE INVENTION

In summary of this disclosure, a modified electrostatic precipitator, preferably a WESP, is provided which utilizes two discharge and collection zones within a common unit. Modifications are possible within the scope of this invention.

What we claim is:

1. An electrostatic precipitator unit, comprising:
an outer housing having an inlet for a gas stream to be treated in the electrostatic precipitator and an outlet for treated gases,
an array of electrically-conducting tubes located within said housing and extending continuously from adjacent said inlet to adjacent said outlet, said array of tubes being electrically grounded to permit said array of tubes to act as collecting surfaces for particulate removal from the gas stream,
pairs of elongate rod electrodes located in each of said tubes, with one member of each pair of electrodes extending a first distance from one end of said tubes and the other member of each pair of electrodes extending a second distance from the other end of said tubes to be spaced apart from one another,
said one member of each pair of electrodes being electrically powered by a first power supply and said other member of each pair of electrodes being electrically powered by a second power supply to permit each pair of electrodes to act as ionizing electrodes for the gas stream,
wherein, in operation, differing power levels may be applied by said first and second power supply to gas flowing through said array of tubes during said first distance and to gas flowing in said array of tubes during said second distance.

2. The unit of claim 1 wherein the tubes have a round cross-section.

3. The unit of claim 1 wherein the tubes have a polygonal cross-section.

4. The unit of claim 3 wherein the tubes have a hexagonal cross-section.

5. The unit of claim 1 configured as a wet electrostatic precipitator unit.

6. The unit of claim 1 wherein the first distance is less than the second distance.

7. The unit of claim 1 wherein said array of electrically-conducting tubes is constructed of a carbon-fiber reinforced cross-linked thermosetting resin.
